(19) United States
(12) Patent Application Publication
(10) Pub. No.: US 2018/0096387 A1
(43) Pub. Date: Apr. 5, 2018

(54) SYSTEM AND METHOD FOR INTEGRATING PAYMENT TRANSACTION BY PAYER WITH TARGETED MARKET PROMOTIONS

(71) Applicant: Anand Vaidyanathan, Chennai (IN)

(72) Inventor: Anand Vaidyanathan, Chennai (IN)

(21) Appl. No.: 15/715,156

(22) Filed: Sep. 26, 2017

(30) Foreign Application Priority Data
Oct. 5, 2016 (IN) 201641034200

(51) Int. Cl. G06Q 30/02; G06Q 20/10; G06Q 20/32; G06Q 20/04; G06Q 50/00

(52) U.S. Cl. CPC G06Q 30/0253; G06Q 30/0224; G06Q 20/102; G06Q 50/01; G06Q 20/3276; G06Q 20/322; G06Q 20/0453; G06Q 20/3278

(57) ABSTRACT

Disclosed is a payment transaction system (106) and method that integrates a payment transaction made by a payer (102) with a payer targeted marketing promotions. The payment transaction system includes the payer (102), a payment integration server (110), a payer device (104), one or more payee devices (108A-N), a market promotions server (116), one or more payees (112A-N). When the payer (102) purchase a product or a service from the one or more payees (112A-N) at a location, using the payment integration server (110), the one or more payer targeted market promotions relevant to the payment transaction are applied either manually or automatically to the payment transaction. The payment transaction system (106) combines a payment process and a marketing process in a seamless manner.

### CROSS REFERENCE TO RELATED APPLICATIONS

This application claims priority to Indian patent application no. 201641034200 filed on Oct. 5, 2016, the complete disclosure of which, in its entirely, is herein incorporated by reference.

### BACKGROUND

### Technical Field

Embodiments of this disclosure generally relate to a payment transaction, and more particularly, to a system and method of integrating a payment transaction with targeted the market promotions.

### Description of the Related Art

In the modern times, mobile communication device like cellular phones, personal digital assistants, etc., are increasingly being used to conduct payment transactions in easy and faster way. Such payment transactions include, for example, purchasing goods and/or services, bill payments, and transferring funds between bank accounts. Moreover, cashless transaction has become a norm because of the obvious advantage over carrying cash. For one, exact amount of cash required need not be anticipated, and secondly it facilitates more secure transaction over cash payment.

Currently, merchants and/or manufacturers may attempt to attract consumers by offering various discounts. Often, the discount may apply to a particular product (e.g., 50% off for Shine sunglasses) or for an amount off a consumer's bill at a merchant, (e.g., 5% off on a purchase of Rs.5000 and above at Walmart). Such discounts may appear in multiple forms. In one example, a merchant may offer a discount in the form of a printed coupon. Such printed coupons is distributed to the public and/or a particular consumer base through numerous channels, such as advertisements in newspapers, magazines, the Internet, direct mailings, etc. For availing the discount, a consumer may be required to present the coupon to the merchant at the time of purchase. Alternatively, a merchant may offer a consumer membership in a loyalty program. Such a program may involve a consumer maintaining a loyalty account, often with the loyalty account number stored either on a transaction card containing a machine-readable storage medium, such as a barcode or magnetic stripe, or on a cloud server with a user login and password to store the loyalty account number. Before payment, or at the same time, the consumer is required to present this loyalty account number to the merchant in order to receive various discounts.

All of the above mentioned methods of distributing discounts to consumers have considerable drawbacks. A loyalty program requiring a consumer to have a loyalty account number may be cumbersome and he/she have to present the loyalty account number every time before or at the same time of purchase, apart from making payment form the bank account number. This may slow down the checkout process. It may also require a substantial investment from the merchant such as the merchant may need to purchase and maintain hardware and software capable of performing tasks such as receiving account loyalty information, processing it, determining which discounts apply to each consumer, and storing consumer data. In the printed coupon-based system may also, the consumer is need to obtain and carry the printed coupon to the merchant to avail the discount that may have the possibility of a lost or misplaced coupon. The checkout process is time consuming since a separate person from merchant side is employed to determine whether the coupon is valid or not, properly record the coupon, and apply the discount to the consumer's purchase. The preparation and distribution of printed coupons may also require a considerable investment of money by the merchant.

Accordingly, there remains a need for a system and method for integrating the payment transaction and the application of market promotions as a single system that is more flexible to use.

### SUMMARY

In view of the foregoing, an embodiment herein provides a payment transaction system that integrates a payment transaction made by a payer with a payer targeted marketing promotions. The payment transaction system includes a payer device and a payment integration server. The payer device includes a memory unit, and a processor. The memory unit stores a set of modules and a payer device database. The processor executes the set of modules. The set of modules includes a payer data communicating module, a payer targeted market promotions receiving module, a payer targeted market promotions displaying module and a payment receipt display module. The payer data communicating module is configured to receive payer data. The payer data includes (i) a profile of the payer, (ii) a payment history of the payer, (iii) a spending pattern of the payer and (iv) a browsing history of the payer. The payer targeted market promotions receiving module is configured to receive one or more payer targeted market promotions based on the payer data. The payer targeted market promotions includes atleast one of (i) a payer targeted coupon data, (ii) a payer targeted loyalty program data, (iii) a payer targeted marketing promotion data, or (iv) a payer targeted social media marketing data. The payer targeted market promotions displaying module is configured to display the one or more payer targeted market promotions related to the payment transaction. The payer targeted market promotions displaying module allows the payer to select the one or more payer targeted market promotions by (i) manually searching and selecting the one or more payer targeted market promotions in real time, or (ii) automatically searching and selecting the one or more payer targeted market promotions against a product or a service to be purchased from the one or more payees in the location. The payment receipt display module is configured to display a receipt after completion of the payment transaction on atleast one of (i) successful completion of the payment transaction, (ii) failure of the payment transaction, (iii) pending of the payment transaction or (iv) cancellation of the payment transaction.

The payment integration server includes a memory unit, and a processor. The memory unit stores a set of modules and a payment integration server database. The processor executes the set of modules. The set of modules includes a payer data analysis module, a market promotions receiving module, a payer targeted market promotions communication module, a payment information obtaining module, a selected payer targeted market promotions application module, a payment transaction module, a payment receipt communication module, a payer data updation module and a payment status communicating module. The payer data analysis module is configured to analyze the payer data in the payment integration server database using a server deep data analytical engine. The market promotions receiving module is configured to receive one or more market promotions of one or more payees and stores in the payment integration server database in real time. The payer targeted market promotions communication module is configured to select one or more market promotions using the server deep data analytical engine based on the payer data and communicates the one or more payer targeted market promotions to the payer device in real time. The payment information obtaining module is configured to (i) generate and communicate a link code associated with the payment transaction to the payee device to display, (ii) obtain the link code using the payer device by the payer through atleast one of (a) QR code, (b) NFC, (c) sound tagging or (d) other similar connections and communicates the link code back to the payment integration server for establishing a connection among the payment integration server, the payer and the payee, and (iii) obtain payment information from the payee device and communicates to the payer device. The payment information includes at least one of (i) a payment amount, (ii) data related to details of the product or the service purchased, (iii) a bank account details of the payer, (iv) a bank account details of the payee, (v) a location of the payee and (vi) other details associated with the payment transaction including one or more additional market promotions. The data related to details of the product or the service purchased includes atleast one of (a) details of a e-commerce website or retailer where the products or the services purchased, (b) specific and granular details of the products or the services purchased (e.g. individual items list) or (c) the browsing history of the payer from where the product or the service purchased is selected for purchase. The selected payer targeted market promotions application module is configured to apply the one or more selected payer targeted market promotions to the payment information. The payment information is modified and modified payment information is displayed using payer device for the payer. The payment transaction module is configured to process the payment transaction between the payer and the one or more payees based on the modified payment data related to the payment transaction. The payment receipt communication module is configured to store the receipt of the payment transaction. The receipt includes atleast one of (i) a bill for the product or the service purchased along with the payer targeted market promotions applied for the payment transaction, (ii) a warranty/guarantee information associated with the product or the service purchased and (iii) data associated with the product or the service and communicates to display the receipt in the payer device for the payer. The payer data updation module is configured to update the payer data of the payer, with atleast one of (i) the payment information, (ii) the modified payment data, (iii) a recent browsing history of the payer, (iv) a recent purchasing history of the payer. The payment status communicating module is configured to communicate the status of the payment transaction to the one or more payees on atleast one of (i) successful completion of the payment transaction, (ii) failure of the payment transaction, (iii) pending of the payment transaction or (iv) cancellation of the payment transaction.

According to one embodiment, the payment transaction system includes one or more payee devices. The one or more payee devices include a memory unit, and a processor. The memory unit stores a set of modules and a payee device database. The processor executes the set of modules. The set of modules includes a payment initiating module, payment information communicating module and a payment status obtaining module. The payment initiating module is configured to allow the one or more payees to initiate the payment transaction against the product or the service purchased from one or more payees in the location. The payment information communicating module is configured to communicate the payment information after initiating the payment transaction. The payment status obtaining module is configured to receive the status after completion of the payment transaction.

According to another embodiment, the payment transaction system includes a market promotion server. The market promotion server includes a memory unit, and a processor. The memory unit stores a set of modules and a market promotions database. The processor executes the set of modules. The set of modules includes market promotions receiving module and a market promotions communication module. The market promotions receiving module is configured to receive one or more market promotions from the one or more payees. The market promotions communication module is configured to communicate the one or more market promotions to the payment integration server at the location in real time.

According to yet another embodiment, the payer device further includes, a market promotions obtaining module, that obtains one or more market promotions using a scanning tool associated with the payer device by scanning the one or more market promotions displayed in at least one of (i) newspapers, pamphlets or other text readable formats, (ii) store aisles, billboards or wall hangings, or (iii) internet or other electronic media and stores in the payment integration server database to utilize in the payer targeted market promotions communication module.

According to yet another embodiment, the payer device further includes, a market promotions sharing module, that enables the payer to share the plurality of payer targeted market promotions along with a message, with at least one of (i) a new payer, or (ii) a plurality of new payers, using a social media tool associated with the payment transaction system to download and utilize in the payer targeted market promotions communication module.

According to yet another embodiment, the payment transaction system includes a plurality of payer devices for initiating a plurality of payment transactions against a plurality of products or services purchased from the one or more payees.

According to yet another embodiment, the payee device further includes a payee server that directly (i) selects the one or more market promotions, (ii) communicates the one or more payer targeted market promotions to the payment integration server in real time.

According to yet another embodiment, the payment transaction system further includes one or more market promotion servers corresponding to the one or more payees.

In one aspect, method for integrating a payment transaction made by a payer with a payer targeted marketing promotions is provided. The method includes the following steps of: (i) analyzing, using a server deep data analytical engine, payer data in the payment integration server, (ii) communicating, using a payment integration server, the payer data to the payer device, (iii) receiving, using a payer data communicating module, the payer data in the payer device for the payer, (iv) receiving, using the payment integration server, one or more market promotions of one or more payees in real time, (v) selecting, using the server deep data analytical engine, one or more market promotions based on the payer data, (vi) communicating, using the payment integration server, one or more payer targeted market promotions to the payer device in real time, (vii) receiving, using the payer device, one or more payer targeted market promotions, (viii) displaying, using the payer device, the one or more payer targeted market promotions related to the payment transaction that allows the payer to select the one or more payer targeted market promotions by (a) manually searching and selecting the one or more payer targeted market promotions, or (b) automatically searching and selecting against a product or a service to be purchased from the payee in the location, (ix) initiating, using one or more payee devices, the payment transaction by the payee against the product or the service purchased by the payer in the location, (x) generating, using the payment integration server database, a link code associated with the payment transaction, (xi) communicating, using the payment integration server database, the link code to the payee device to display, (xii) obtaining, using the payer device, by the payer, through atleast one of (a) QR code, (b) NFC, (c) sound tagging or (d) other similar connections, (xiii) communicating, using the payer device, by the payer the link code back to the payment integration server for establishing a connection among the payment integration server, the payer and the payee, (xiv) obtaining, using the payment integration server database, a payment information associated with the payment transaction initiated by the payee, (xv) applying, using the payment integration server, the one or more selected payer targeted market promotions to the payment information, (xvi) processing, using the payment integration server, the payment transaction between the payer and the one or more payees, based on the modified payment data related to the payment transaction, (xvii) storing, using the payment integration server, a receipt and communicating the receipt to display in the payer device, (xviii) communicating, using the payment integration server, a status to the payee device of the payment transaction on atleast one of (a) successful completion of the payment transaction, (b) failure of the payment transaction, (c) pending of the payment transaction or (d) cancellation of the payment transaction, (xix) updating, using payer data updation module, the payer data of the payer in the payment integration server database, based on atleast one of (a) the payment information, (b) the modified payment data, (c) a recent browsing history of the payer, (d) a recent purchasing history of the payer, (xx) displaying, using the payer device, the receipt after completion of the payment transaction, on atleast one of (a) successful completion of the payment transaction, (b) failure of the payment transaction, (c) pending of the payment transaction or (d) cancellation of the payment transaction, (xxi) receiving, using the one or more payee devices, the status after completion of the payment transaction.

The payer data includes (a) a profile of the payer, (b) a payment history of the payer, (c) a spending pattern of the payer, and (d) a browsing history of the payer. The payer targeted market promotions includes atleast one of (i) a payer targeted coupon data, (ii) a payer targeted loyalty program data, (iii) a payer targeted marketing promotion data, or (iv) a payer targeted social media marketing data. The payment information includes at least one of (i) a payment amount, (ii) data related to details of the product or the service purchased, (iii) a bank account details of the payer, (iv) a bank account details of the payee, (v) a location of the payee and (vi) other details associated with the payment transaction including one or more additional market promotions. The data includes atleast one of (a) details of an e-commerce website or retailer where the products or the services purchased, (b) specific and granular details of the products or the services purchased (e.g. individual items list) (c) the browsing history of the payer from where the product or the service purchased is selected for purchase. The payment information is modified and modified payment information is displayed using payer device for the payer. The receipt includes atleast one of (i) a bill for the product or the service purchased along with the payer targeted market promotions applied for the payment transaction; (ii) a warranty/guarantee information associated with the product or the service purchased and (iii) data associated with the product or the service.

According to one embodiment, the further includes (i) receiving, using a market promotion server, one or more market promotions from the one or more payees, and (ii) communicating, using the market promotion server, the one or more market promotions to the payment integration server of the location in real time.

According to another embodiment, the method further includes obtaining, using a market promotions obtaining module the one or more market promotions by a scanning tool associated with the payer device that scans the one or more market promotions displayed in at least one of (i) newspapers, pamphlets or other text readable formats, (ii) store aisles, billboards or wall hangings, or (iii) internet or other electronic media and stores in the payment integration server database for the payer to utilize in the payer targeted market promotions communication module.

According to yet another embodiment, the method further includes enabling the payer, using a market promotions sharing module, to share the plurality of payer targeted market promotions along with a message, with at least one of (i) a new payer, or (ii) a plurality of new payers, by a social media tool associated with the payment transaction system and also to download and utilize in the payer targeted market promotions communication module.

According to yet another embodiment, the method further includes: initiating a plurality of payment transactions, using a plurality of payer devices, against a plurality of the products or the services purchased from the one or more payees.

According to yet another embodiment, the method further includes: (i) selecting one or more market promotions, using a payee server in the each payee device, the one or more payer targeted market promotions to the payer device in real time, (ii) communicating, using a payee server in the each payee device, the one or more payer targeted market promotions to the payment integration server in real time.

According to yet another embodiment, the method further includes: having one or more market promotion servers corresponding to one or more payees.

The system and method for integrating the payment transaction made by the payer with the payer targeted marketing promotions is simple, unique and versatile. This payment transaction system allows one or more payers to initiate the plurality of payment transactions on the purchase of plurality of products from a plurality of payees in a frictionless manner. The system combines payment process and marketing process in a seamless manner. From the start of the initiation of the payment transaction till the receipt of the bill associated with the payment transaction can be seen in the payer device by the payer. Hence, this proposed system is very convenient to use and there is no need to separately look for coupons or discounts specific for the purchase, for the payee or for the payer. This system enables the payer to purchase for a particular product or from a particular payee even in a location which he/she never visited as the market promotions are automatically displayed in the payer device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of integration of the payment transaction made by the payer with the payer targeted marketing promotions, using a payment transaction system according to an embodiment herein;

FIG. 2 illustrates an exploded view of a payer device of FIG. 1 according to an embodiment herein;

FIG. 3 illustrates an exploded view of a payment integration server of FIG. 1 according to an embodiment herein;

FIG. 4 illustrates an exploded view of a payee device 112A of FIG. 1 according to an embodiment herein;

FIG. 5 illustrates an exploded view of a market promotions server 116 of FIG. 1 according to an embodiment herein;

FIGS. 6A, 6B & 6C are flow diagrams illustrating a method of integrating a payment transaction made by the payer with the payer targeted marketing promotions of FIG. 1 according to an embodiment herein;

FIG. 7 illustrates an exploded view of a payer communication device according to the embodiments herein; and

FIG. 8 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

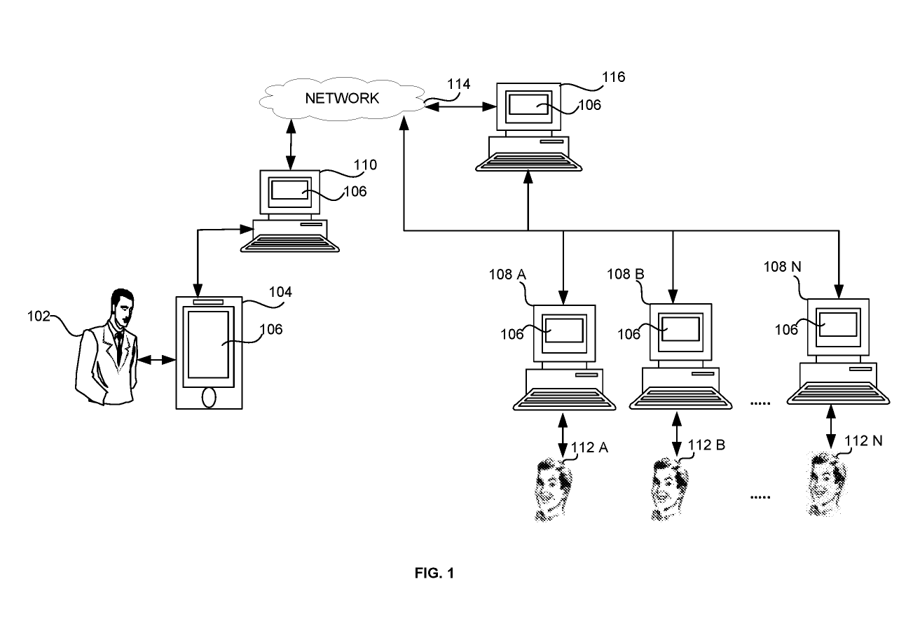

As mentioned, there remains, a need for a system and method for integrating the payment transaction and the application of market promotions as a single system that is more flexible to use. The embodiments herein achieve this, by providing a payment transaction system and method for integrating a payment transaction made by a payer with a payer targeted marketing promotions. Referring now to the drawings, and more particularly to FIG. 1 through FIG. 9, where similar reference characters denote corresponding features consistently throughout the figures, there are shown preferred embodiments.

FIG. 1 illustrates a system view of integration of the payment transaction made by the payer 102 with the payer targeted marketing promotions, using a payment transaction system 106 according to an embodiment herein. The system view includes the payer 102, a payer device 104, the payment transaction system 106, one or more payee devices 108A-N, a payment integration server 110, one or more payees 112A-N, a network 114 and a market promotion server 116.

The payment integration server 110 analyses a payer data using a server deep data analytical engine in the payment integration server database 302 and communicated to the payer device 104 for display to the payer 102 using a network 114. In one embodiment, the network 114 may include, but not limited to, an internet, intranet, a wide area network, a wired cable network, a broadcasting network, a wired communication network, a wireless communication network, a fixed wireless network, a mobile wireless network, and the like. The payment integration server 110 further receives one or more market promotions from a market promotions server 116. The one or more market promotions are analyzed and selected using the server deep data analytical engine based on the payer data, and one or more payer targeted market promotions are communicated to the payer device 104 to display. After initiating the payment transaction by payee 112A in the payee device 108A, the payment information is communicated to the payment integration server 110. The payment information is modified as the selected payer targeted market promotions are applied and the modified payment information is displayed in the payer device 104. The payment integration server 110 processes the payment transaction based on the modified payment transaction and communicates the receipt to the payer device 104 for the payer. The payment integration server 110 further communicates the status of the payment transaction to the payee device 108A.

In one embodiment, the payment transaction system includes one or more payee devices 108A-N for initiating a plurality of payment transactions against a plurality of products or services purchased from the one or more payees 112A-N in a location.

In one embodiment, the payer device 110 is a wireless mobile communication device, such as a cell phone, a smart phone, a tablet or personal digital assistance (PDA), a personal computer (PC), a laptop, a desktop, an ultra-book, any other network device capable of connecting to the network 114 for operational purposes. In one embodiment, the payee device 106 is a personal computer (PC), a handheld PC, a laptop, mobile phone, a desktop, a website, an ultra-book, any other network device capable of connecting to the network 114 for operational purposes. In one embodiment, the payment integration server 110 is a cloud server. In one embodiment, the market promotions server 116 is a cloud server.

In one embodiment, the payment transaction system 106 includes a plurality of payer devices for initiating a plurality of payment transactions against a plurality of products or services purchased from the one or more payees 112A-N.

In one embodiment, the payment transaction system 106 includes one or more market promotion servers corresponding to the one or more payees 112A-N.

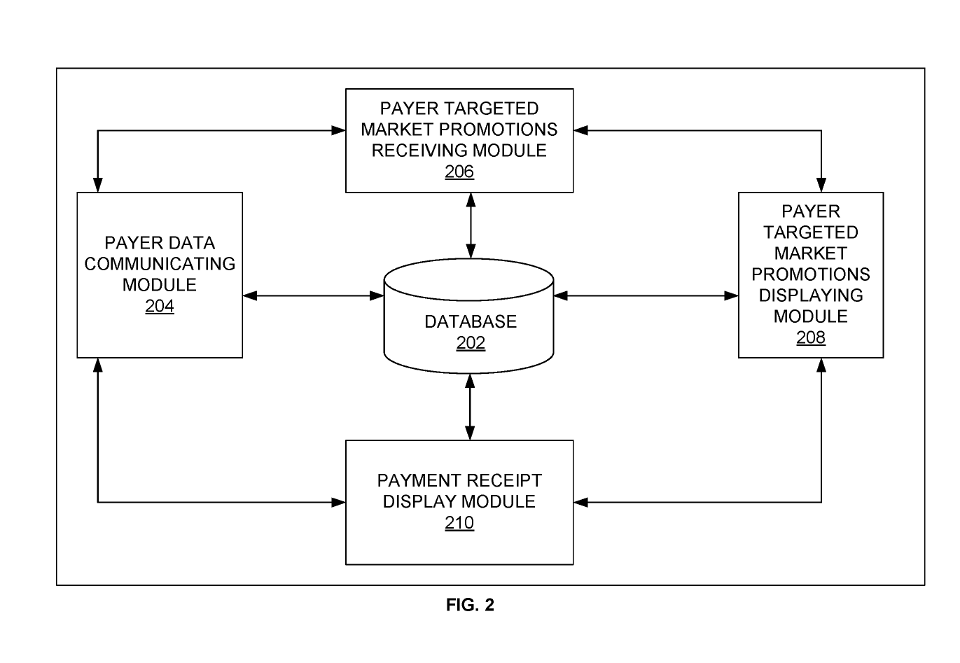

FIG. 2 illustrates an exploded view of the payer device 104 of FIG. 1 according to an embodiment herein. The payer device 104 includes a payer database 202, a payer data communicating module 204, a payer targeted market promotions receiving module 206, a payer targeted market promotions displaying module 208 and a payment receipt display module 210. The payer data communicating module 204 receives the payer data from the payer device 104. In one embodiment, the payer data communicating module communicates the payer data from the payment integration server 110. The payer data includes include (i) a profile of the payer 102, (ii) a payment history of the payer 102, (iii) a spending pattern of the payer 102, and (iv) a browsing history of the payer 102. In one embodiment, the profile of the payer includes name, contact details, address and other personal identification details of the payer 102 that is updated in real time by the payer 102. In another embodiment, the payer data is updated by the payer 102 in real time. The payer targeted market promotions receiving module 206 receives one or more payer targeted market promotions. The payer targeted market promotions includes atleast one of (i) a payer targeted coupon data, (ii) a payer targeted loyalty program data, (iii) a payer targeted marketing promotion data, or (iv) a payer targeted social media marketing data. In one embodiment, the one or more payer targeted market promotions are discount cards, coupons, free entry or show tickets, cash back offer cards, refundable customer point cards, product exchange offer cards or membership cards with loyalty points. The payer targeted market promotions displaying module 208 displays the one or more payer targeted market promotions related to the payment transaction, that allows the payer 102 to select the one or more payer targeted market promotions by (i) manually searching and selecting the one or more payer targeted market promotions in real time, or (ii) automatically searching and selecting the one or more payer targeted market promotions against a product or a service to be purchased from the one or more payees 112A-N in the location. In one embodiment, the payer targeted market promotions displaying module 210 allows the payer 102 to select the one or more payer targeted market promotions of one or more payees 112A-N. The payment receipt display module 210 displays the receipt after completion of the payment transaction, on atleast one of (i) successful completion of the payment transaction, (ii) failure of the payment transaction, (iii) pending of the payment transaction or (iv) cancellation of the payment transaction. In one embodiment, the receipt includes atleast one of (i) a bill for the products or the services purchased along with the payer targeted market promotions applied for the payment transactions, (ii) a warranty/guarantee information associated with the product or the service purchased and (iii) data associated with the product or the service. In one embodiment, the data associated with the product or the service includes a loyalty points or a referral points associated to the payment transaction that is added to the profile of the payer 102.

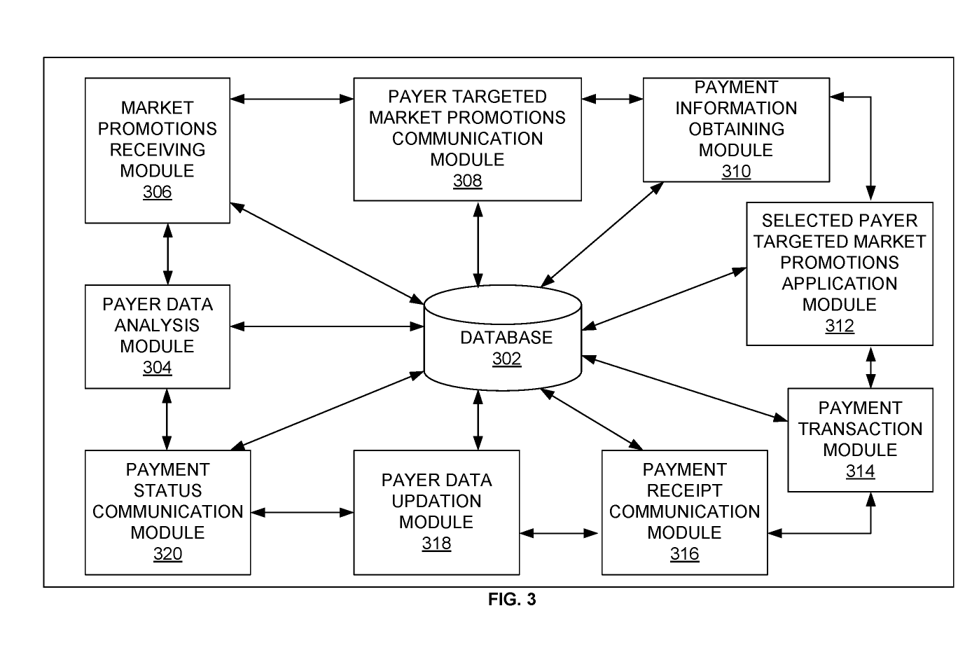

FIG. 3 illustrates an exploded view of the payment integration server 110 of FIG. 1 according to an embodiment herein. The payment integration server 110 includes a payment integration server database 302, a payer data analysis module 304, a market promotions receiving module 306, a payer targeted market promotions communication module 308, a payment information obtaining module 310, a selected payer targeted market promotions application module 312, a payment transaction module 314, a payment receipt communication module 316, a payer data updation module 318 and a payment status communicating module 320. The payer data analysis module 304 analyses the payer data in the payment integration server database 302 using a server deep data analytical engine. The market promotions receiving module 306 receives one or more market promotions of one or more payees 112A-N and stores in the payment integration server database 302 in real time. In one embodiment, the one or more market promotions of one or more payees 112A-N are stored and updated periodically. The payer targeted market promotions communication module 308 selects one or more market promotions using the server deep data analytical engine based on the payer data and communicates the one or more payer targeted market promotions to the payer device in real time. In one embodiment, after selection of the one or more payer targeted market promotions, the payment integration server 110 checks in real time, atleast one of (i) the authenticity of the one or more payer targeted market promotions, (ii) validity period of the one or more payer targeted market promotions, or (iii) eligibility of the payer 102 for the one or more payer targeted market promotions. The payment information obtaining module 310 that generates and communicates a link code associated with the payment transaction to the payee device 108A to display. The payment information obtaining module 310 further obtains the link code using the payer device 104 by the payer 102 through atleast one of (a) QR code, (b) NFC, (c) sound tagging or (d) other similar connections and communicates the link code back to the payment integration server 110 for establishing a connection among the payment integration server 110, the payer 102 and the payee 112A. The payment information obtaining module 310, obtains the payment information from the payee device 108A and communicates to the payer device 104. In one embodiment, the payment information includes at least one of (i) a payment amount, (ii) data related to details of the product or the service purchased, (iii) a bank account details of the payer 102, (iv) a bank account details of the payee 112A, (v) a location of the payee 112A and (vi) other details associated with the payment transaction including one or more additional market promotions. In one embodiment, the data includes atleast one of (a) details of a e-commerce website or retailer where the products or the services purchased, (b) specific and granular details of the products or the services purchased (e.g. individual items list) or (c) the browsing history of the payer from where the product or the service purchased.

The selected payer targeted market promotions application module 312 applies the one or more selected payer targeted market promotions to the payment information. The payment information is modified and modified payment information is displayed using the payer device 104 for the payer 102. The payment transaction module 314 processes the payment transaction between the payer 102 and the one or more payees 112A-N based on the modified payment data related to the payment transaction. The payment receipt communication module 316 communicates the receipt to the payer device 104 on atleast one of (i) successful completion of the payment transaction, (ii) failure of the payment transaction, (iii) pending of the payment transaction or (iv) cancellation of the payment transaction. The payer data updation module 318 updates the payer data of the payer 102, with atleast one of (i) the payment information, (ii) the modified payment data, (iii) a recent browsing history of the payer 102, (iv) a recent purchasing history of the payer 102. In one embodiment, the payer data updation module 318 updates the payer data of the payer 102 for every payment made by the payer 102 using payment transaction system 106. The payment status communicating module 320 communicates the status of the payment transaction to the one or more payees 112A-N on atleast one of (i) successful completion of the payment transaction, (ii) failure of the payment transaction, (iii) pending of the payment transaction or (iv) cancellation of the payment transaction.

In one embodiment, the payer device 104 further includes, a market promotions obtaining module, that obtains one or more market promotions using the scanning tool associated with the payer device by scanning the one or more market promotions displayed in at least one of (i) newspapers, pamphlets or other text readable formats, (ii) store aisles, billboards or wall hangings, or (iii) internet, social media or other electronic media and stores in the payment integration server database 302 for the payer 102 to utilize in the payer targeted market promotions communication module 310. In one embodiment, the a market promotions obtaining module obtains one or more market promotions using the scanning tool associated with the payer device 104 by scanning the one or more market promotions displayed in text format, pictures, QR code, barcode, or any other displaying formats used for identification.

In one embodiment, the payer device 104 further includes, a market promotions sharing module, that enables the payer 102 to share the plurality of payer targeted market promotions along with a message, with at least one of (i) a new payer, or (ii) a plurality of new payers, using a social media tool associated with the payment transaction system to download and utilize in the payer targeted market promotions communication module 310. In one embodiment, a market promotions sharing module enables the payer 102 to share the plurality of payer targeted market promotions along with the message that includes 140 characters length.

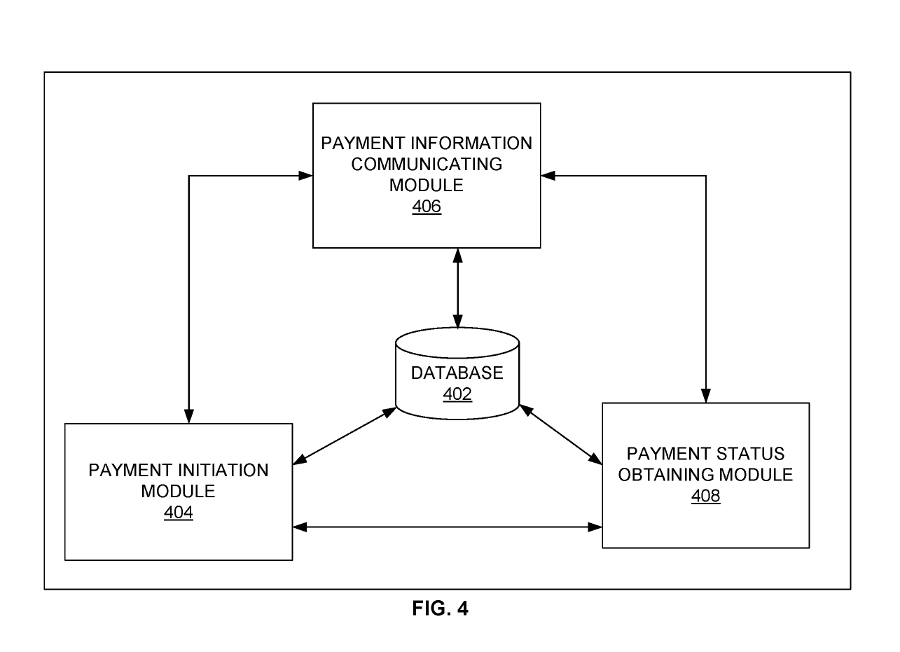

FIG. 4 illustrates an exploded view of a payee device 112A of FIG. 1 according to an embodiment herein. The payee device 112A includes a payee device database 402, a payment initiating module 404, a payment information communicating module 406 and a payment status obtaining module 408. The payment initiating module 404 allows the one or more payees 112A-N to initiate the payment transaction against the product or the service purchased from the payee in the location. In one embodiment, the payment transaction is initiated by the one or more payees 112A-N in the one or more payee devices 108A-N. In another embodiment, the payment transaction is initiated by the one or more payees 112A-N in the one or more payee devices 108A-N using an e-commerce website. In yet another embodiment, the payment transaction is initiated by the one or more payees 112A-N in the one or more payee devices 108A-N using an online store. The payment information communicating module 406 communicates the payment information after initiating the payment transaction. The payment status obtaining module 408 receives the status after completion of the payment. In one embodiment, the status is stored in the payee device database 402. In one embodiment payee device 108A, further includes a payee server that directly (i) selects one or more market promotions, (ii) communicates the one or more payer targeted market promotions to the payment integration server 110 in real time.

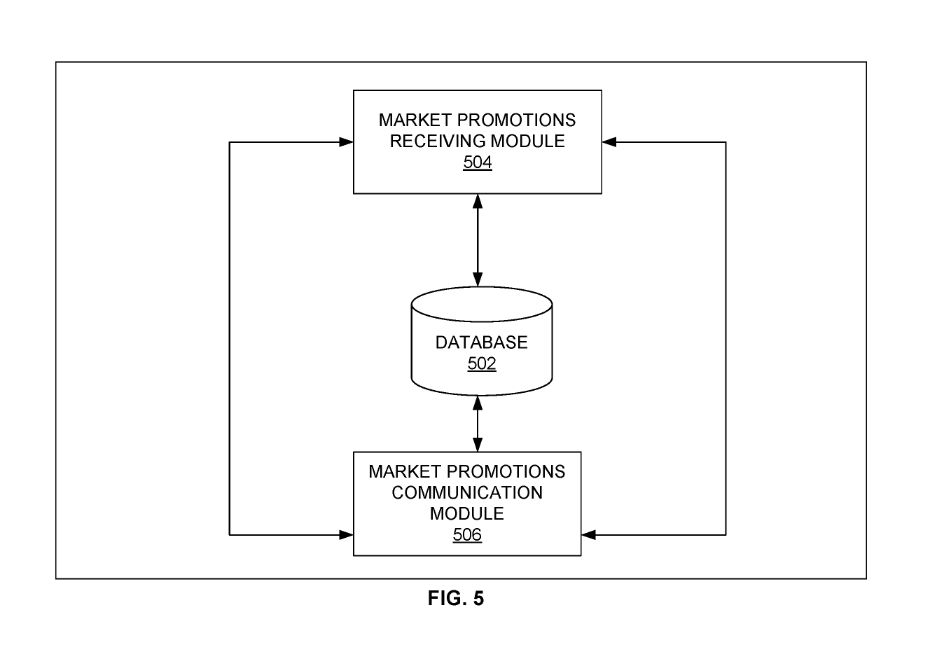

FIG. 5 illustrates an exploded view of a market promotions server 116 of FIG. 1 according to an embodiment herein. The market promotions server 116 includes a market promotions database 502, a market promotions receiving module 504 and a market promotions communication module 506. The market promotions receiving module 504 receives one or more market promotions from the one or more payees 112A-N. In one embodiment, the market promotions receiving module 504 receives one or more market promotions from the one or more payees 112A-N in real time and stored in market promotions database 502. In another embodiment, the market promotions receiving module 504 receives one or more market promotions from the one or more payees 112A-N periodically and stored in market promotions database 502. The market promotions communication module 506 communicates the one or more market promotions to the payment integration server 110 at the location in real time.

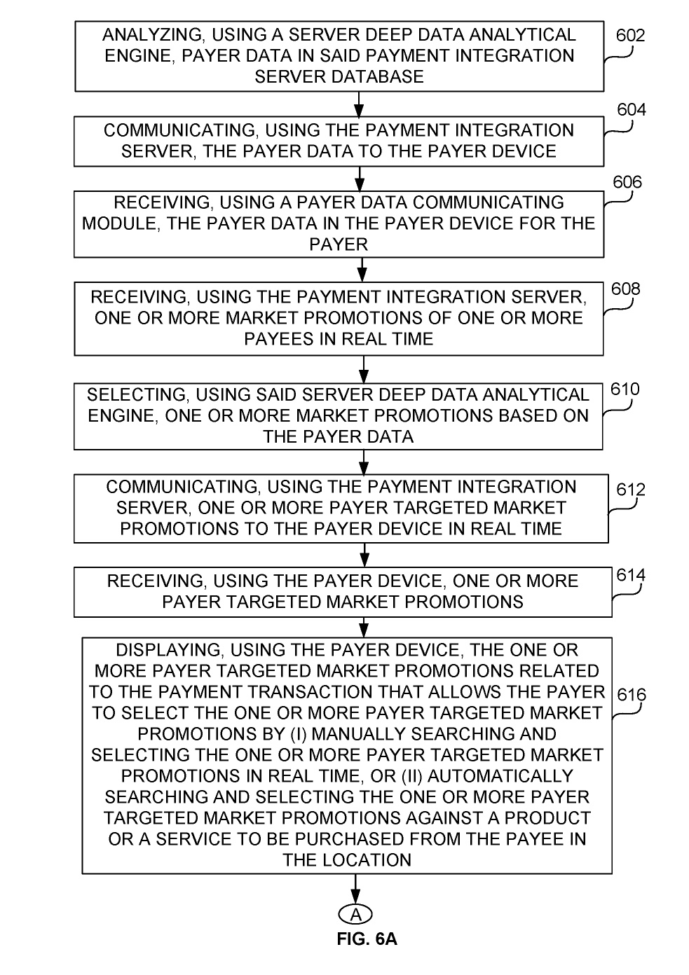

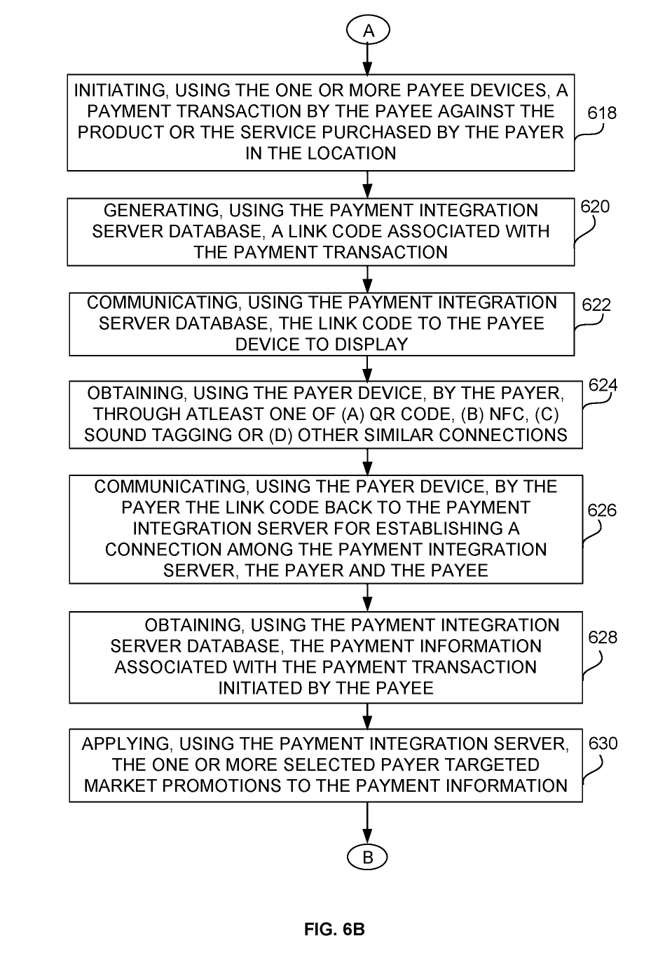

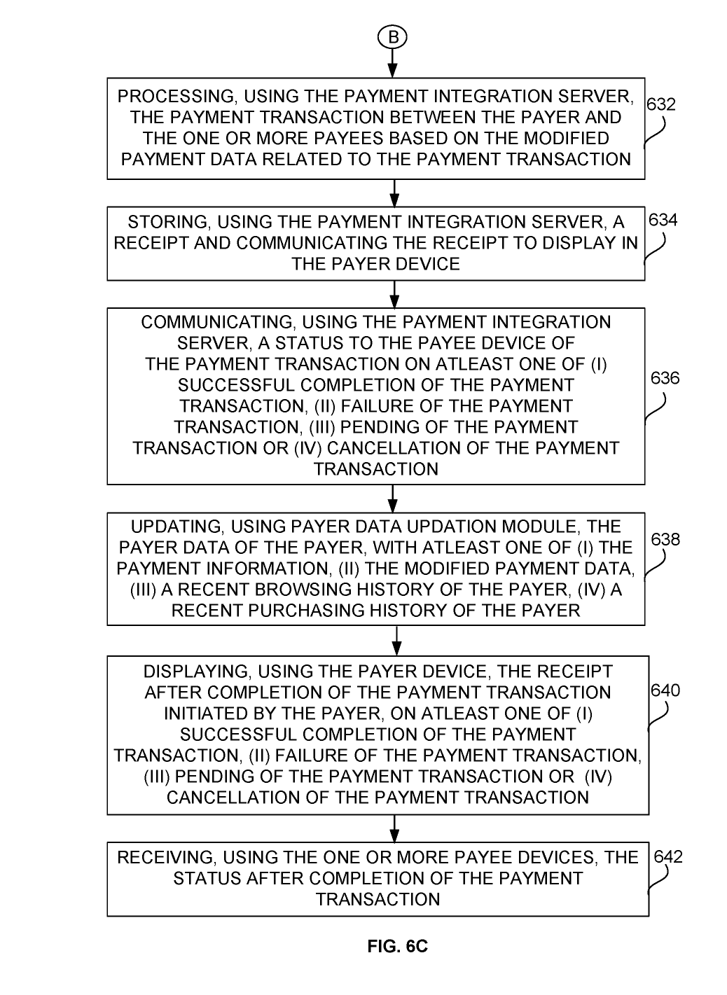

FIGS. 6A, 6B & 6C are flow diagrams illustrating a method of integrating a payment transaction made by the payer with the payer targeted marketing promotions of FIG. 1 according to an embodiment herein. At step 602, payer data in the payment integration server database 302 is analyzed using the server deep data analytical engine. In one embodiment, the payer data includes (i) a profile of the payer 102, (ii) a payment history of the payer 102, (iii) a spending pattern of the payer 102, and (iv) a browsing history of the payer 102. At step 604, the payer data is communicated using the payment integration server 110 to the payer device 104. At step 606, the payer data is received using a payer data communication module 204, in the payer device 104 for the payer 102. At step 608, one or more market promotions of one or more payees 112A-N is received using the payment integration server 110 in real time. At step 610, the one or more market promotions are selected using the server deep data analytical engine based on the payer data in real time. In one embodiment, the one or more market promotions are selected using the server deep data analytical engine based on the payer data that is updated with recent purchase of the payer 102. In another embodiment, the one or more market promotions are selected using the server deep data analytical engine based on the payer data that is updated with recent browsing history of the payer 102. At step 612, the one or more payer targeted market promotions are communicated using the payment integration server 110 to the payer device 104 in real time. In one embodiment, the payer targeted market promotions includes atleast one of (i) a payer targeted coupon data, (ii) a payer targeted loyalty program data, (iii) a payer targeted marketing promotion data, or (iv) a payer targeted social media marketing data. At step 614, the one or more payer targeted market promotions are received using the payer device 104. At step 616, the one or more payer targeted market promotions related to the payment transaction is displayed using the payer device 104, that allows the payer 102 to select the one or more payer targeted market promotions by (a) manually searching and selecting the one or more payer targeted market promotions, or (b) automatically searching and selecting against the product or the service to be purchased from the payee 112A in the location. In one embodiment, after selection of the one or more payer targeted market promotions, the payment integration server 110 checks in real time, atleast one of (i) the authenticity of the one or more payer targeted market promotions, (ii) validity period of the one or more payer targeted market promotions, or (iii) eligibility of the payer 102 for the one or more payer targeted market promotions

At step 618, the payment transaction is initiated by the payee 112A using one or more payee devices 108A-N against the product or the service purchased by the payer 102. At step 620, a link code associated with the payment transaction is generated by the payment integration server 110. At step 622, the link code is communicated to the payee device 108A to display by the payment integration server 110. At step 624, the link code is obtained by the payer 102 using the payer device 104 through atleast one of (a) QR code, (b) NFC, (c) sound tagging or (d) other similar connections. At step 626, the link code is communicated back to the payment integration server 110, for establishing a connection among the payment integration server 110, the payer 102 and the one or more payees 112A-N. At step 628, the payment information is obtained by the payment integration server 110 from the payee 104 and the payment integration server 110 communicates the payment information to the payer 102. In one embodiment, the payment information includes at least one of (i) a payment amount, (ii) data related to details of the product or the service purchased, (iii) a bank account details of the payer 102, (iv) a bank account details of the payee 112A, and (v) other details associated with the payment transaction including one or more additional market promotions. In one embodiment, the data includes atleast one of (a) details of an e-commerce website or retailer where the products or the services purchased, (b) specific and granular details of the products or the services purchased (e.g. individual items list) or (c) the browsing history of the payer 102 from where the product or the service purchased is selected for purchase. At step 630, the one or more selected payer targeted market promotions are applied using the payment integration server 110 to the payment information. In one embodiment, the payment information is modified and modified payment information is displayed using payer device 104 for the payer 102. In one embodiment, after selection of the one or more payer targeted market promotions, the payment integration server 110 checks in real time, atleast one of (i) the authenticity of the one or more payer targeted market promotions, (ii) validity period of the one or more payer targeted market promotions, or (iii) eligibility of the payer 102 for the one or more payer targeted market promotions. At step 632, the payment transaction is processed between the payer 102 and the one or more payees 112A-N, based on the modified payment data related to the payment transaction. At step 634, the receipt is stored and communicated using the payment integration server 110 to display in the payer device 104. In one embodiment, the receipt includes atleast one of (i) a bill for the product or the service purchased along with the payer targeted market promotions applied for the payment transaction; (ii) a warranty/guarantee information associated with the product or the service purchased and (iii) data associated with the product or the service purchased. At step 636, the status of the payment transaction is communicated using the payment integration server 110 to the payee device 108A on atleast one of (a) successful completion of the payment transaction, (b) failure of the payment transaction, (c) pending of the payment transaction or (d) cancellation of the payment transaction. At step 638, the payer data of the payer is updated using payer data updation module 320 in the payment integration server database 302, with atleast one of (a) the payment information, (b) the modified payment data, (c) a recent browsing history of the payer 102, (d) a recent purchasing history of the payer 102. At step 640, the receipt after completion of the payment transaction is displayed using the payer device 104 on atleast one of (a) successful completion of the payment transaction, (b) failure of the payment transaction, (c) pending of the payment transaction or (d) cancellation of the payment transaction. At step 642, the status after completion of the payment transaction is received using the one or more payee devices 108A-N.

In one embodiment, the method further includes (i) receiving, using a market promotion server 116, one or more market promotions from the one or more payees 112A-N, and (ii) communicating, using the market promotion server 116, the one or more market promotions to the payment integration server 110 of the location in real time. In another embodiment, the method further includes: having one or more market promotion servers corresponding to one or more payees 112A-N.

In one embodiment, the method further includes obtaining, using a market promotions obtaining module the one or more market promotions by a scanning tool associated with the payer device that scans the one or more market promotions displayed in at least one of (i) newspapers, pamphlets or other text readable formats, (ii) store aisles, billboards or wall hangings, or (iii) internet or other electronic media and stores in the payment integration server database 302 for the payer to utilize in the payer targeted market promotions communication module 310.

In one embodiment, the method further includes enabling the payer, using a market promotions sharing module, to share the plurality of payer targeted market promotions along with a message, with at least one of (i) a new payer, or (ii) a plurality of new payers, by a social media tool associated with the payment transaction system and also to download and utilize in the payer targeted market promotions communication module 310.

In one embodiment, the method further includes: initiating a plurality of payment transactions, using a plurality of payer devices, against a plurality of the products or the services purchased from the one or more payees 112A-N.

In another embodiment, the method further includes: (i) selecting one or more market promotions, using a payee server in the each payee device 108A, the one or more payer targeted market promotions to the payer device 104 in real time, (ii) communicating, using a payee server in the each payee device 108A, the one or more payer targeted market promotions to the payment integration server 110 in real time. In one embodiment, the one or more market promotions that are selected and applied by the payer 102 are communicated to the payee server by the payment integration server 110.

In one embodiment, the receipt received using the payer device 104 is stored in the payment integration server database 302. In one embodiment, the receipts are searched and displayed in the payer device 104 when the payer 102 wants to return or resell the product or the service purchased. In another embodiment, the receipts are searched and displayed the payer device 104 when the payer 102 is need of a warranty or guarantee information for the product or the service purchased.

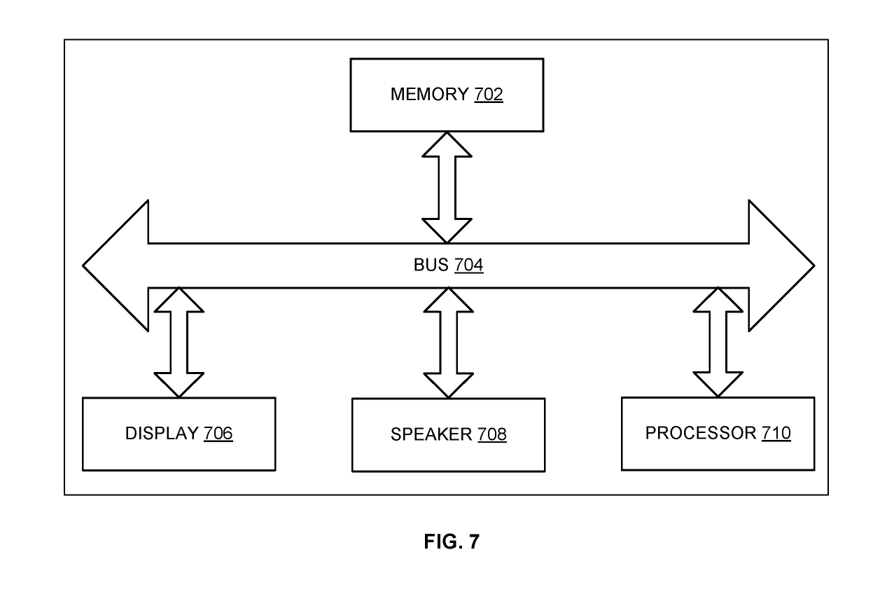

FIG. 7 illustrates an exploded view of the personal communication device having an a memory 702 having a set of computer instructions, a bus 704, a display 706, a speaker 708, and a processor 710 capable of processing a set of instructions to perform any one or more of the methodologies herein, according to an embodiment herein. In one embodiment, the receiver may be the personal communication device. The processor 710 may also enable digital content to be consumed in the form of video for output via one or more displays 706 or audio for output via speaker and/or earphones 708. The processor 710 may also carry out the methods described herein and in accordance with the embodiments herein.

Digital content may also be stored in the memory 702 for future processing or consumption. The memory 702 may also store program specific information and/or service information (PSI/SI), including information about digital content (e.g., the detected information bits) available in the future or stored from the past. A user of the personal communication device may view this stored information on display 706 and select an item of for viewing, listening, or other uses via input, which may take the form of keypad, scroll, or other input device(s) or combinations thereof. When digital content is selected, the processor 710 may pass information. The content and PSI/SI may be passed among functions within the personal communication device using the bus 704.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

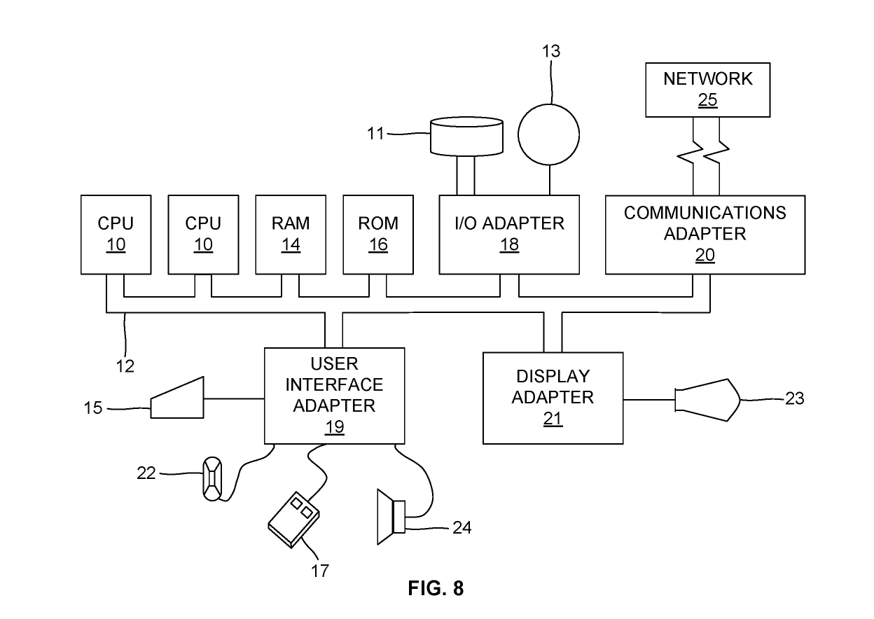

A representative hardware environment for practicing the embodiments herein is depicted in FIG. 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A payment transaction system (106) that integrates a payment transaction made by a payer (102) with a payer targeted marketing promotions, comprising:
A) a payer device (104) that comprises
a memory unit that stores (a) a set of modules, and (b) a payer device database (202); and
a processor which executes said set of modules, wherein said set of modules comprises:
a payer data communicating module (204), implemented by the processor, that receives payer data from the payment integration server that comprises (i) a profile of said payer (102), (ii) a payment history of said payer (102), (iii) a spending pattern of said payer (102), and (iv) a browsing history of said payer (102);
a payer targeted market promotions receiving module (206), implemented by the processor, that receives one or more payer targeted market promotions, wherein said payer targeted market promotions comprises atleast one of (i) a payer targeted coupon data, (ii) a payer targeted loyalty program data, (iii) a payer targeted marketing promotion data, or (iv) a payer targeted social media marketing data;
a payer targeted market promotions displaying module (208), implemented by the processor, that displays said one or more payer targeted market promotions related to said payment transaction, wherein said payer targeted market promotions displaying module (208) allows said payer (102) to select said one or more payer targeted market promotions by (i) manually searching and selecting said one or more payer targeted market promotions in real time, or (ii) automatically searching and selecting said one or more payer targeted market promotions against a product or a service to be purchased from said one or more payees (112A-N) in said location; and
a payment receipt display module (210), implemented by the processor, that displays a receipt after completion of said payment transaction, on atleast one of (i) successful completion of said payment transaction, (ii) failure of said payment transaction, (iii) pending of said payment transaction or (iv) cancellation of said payment transaction;
B) a payment integration server (110) that comprises
a memory unit that stores (a) a set of modules, and (b) a payment integration server database (302); and
a processor which executes said set of modules, wherein said set of modules comprises:
a payer data analysis module (304), implemented by the processor, that analyses said payer data in said payment integration server database (302) using a server deep data analytical engine;
a market promotions receiving module (306), implemented by the processor, that receives one or more market promotions of one or more payees (112A-N) and stores in said payment integration server database (302) in real time;
a payer targeted market promotions communication module (308), implemented by the processor, that selects one or more market promotions using said server deep data analytical engine based on said payer data and communicates said one or more payer targeted market promotions to said payer device in real time;
a payment information obtaining module (310), implemented by the processor, that
generates and communicates a link code associated with said payment transaction to said payee device 108A to display;
obtains, said link code using said payer device 104 by said payer 102 through atleast one of (a) QR code, (b) NFC, (c) sound tagging or (d) other similar connections and communicates said link code back to said payment integration server 110 for establishing a connection among said payment integration server 110, said payer 102 and said payee 112A; and
obtains payment information from said payee device 108A and communicates to said payer device 104, wherein said payment information comprises at least one of (i) a payment amount, (ii) data related to details of said product or said service purchased, wherein said data comprises atleast one of (a) details of a e-commerce website or retailer where said products or said services purchased, (b) specific and granular details of said products or said services purchased or (c) said browsing history of said payer from where said product or said service purchased is selected for purchase, (iii) a bank account details of said payer (102), (iv) a bank account details of said payee (112A), (v) a location of said payee (112A) and (vi) other details associated with said payment transaction including one or more additional market promotions;
a selected payer targeted market promotions application module (312), implemented by the processor, that applies said one or more selected payer targeted market promotions to said payment information, wherein said payment information is modified and modified payment information is displayed using said payer device (104) for said payer (102);
a payment transaction module (314), implemented by the processor, that processes said payment transaction between said payer (102) and said one or more payees (112A-N), based on said modified payment data related to said payment transaction;
a payment receipt communication module (316), implemented by the processor, stores said receipt of said payment transaction wherein said receipt comprises atleast one of (i) a bill for said product or said service purchased along with said payer targeted market promotions applied for said payment transaction, (ii) a warranty/guarantee information associated with said product or said service purchased and (iii) data associated with said product or said service and communicates to display said receipt in said payer device (104) for said payer (102);
a payer data updation module (318), implemented by the processor, that updates said payer data of said payer (102), with atleast one of (i) said payment information, (ii) said modified payment data, (iii) a recent browsing history of said payer (102), (iv) a recent purchasing history of said payer (102) and
a payment status communicating module (320), implemented by the processor, that communicates said status of said payment transaction to said one or more payees (112A-N) on atleast one of (i) successful completion of said payment transaction, (ii) failure of said payment transaction, (iii) pending of said payment transaction or (iv) cancellation of said payment transaction.

2. The payment transaction system (106) as claimed in claim 1, wherein said system further comprises one or more payee device (108A-N), wherein said each payee device (108A) that comprises:
a memory unit that stores (a) a set of modules, and (b) a payee device database (402); and
a processor which executes said set of modules, wherein said set of modules comprises:
a payment initiating module (404), implemented by the processor, that allows said one or more payees (112A-N) to initiate said payment transaction against said product or said service purchased by said payer (102) in said location;
a payment information communicating module (406), implemented by the processor, that communicates said payment information after initiating said payment transaction and
a payment status obtaining module (408), implemented by the processor, that receives said status after completion of said payment.

3. The payment transaction system (106) as claimed in claim 1, wherein said system further comprises a market promotion server (116) that comprises:
a memory unit that stores (a) a set of modules, and (b) a market promotions database (502); and
a processor which executes said set of modules, wherein said set of modules comprises:
a market promotions receiving module (504), implemented by the processor, that receives one or more market promotions from said one or more payees (112A-N); and
a market promotions communication module (506), implemented by the processor, that communicates said one or more market promotions to said payment integration server (110) at said location in real time.

4. The payment transaction system (106) as claimed in claim 1, wherein said payer device (104) further comprises, a market promotions obtaining module, that obtains one or more market promotions using a scanning tool associated with said payer device (104) by scanning said one or more market promotions displayed in at least one of (i) newspapers, pamphlets or other text readable formats, (ii) store aisles, billboards or wall hangings, or (iii) internet or other electronic media and stores in said payment integration server database (302) to utilize in said payer targeted market promotions communication module (310).

5. The payment transaction system (106) as claimed in claim 1, wherein said payer device (104) further comprises, a market promotions sharing module, that enables said payer (102) to share said plurality of payer targeted market promotions along with a message, with at least one of (i) a new payer, or (ii) a plurality of new payers, using a social media tool associated with said payment transaction system (106) to download and utilize in said payer targeted market promotions communication module (310).

6. The payment transaction system (106) as claimed in claim 1, wherein said payment transaction system comprises a plurality of payer devices (104) for initiating a plurality of payment transactions against a plurality of products or services purchased from said one or more payees (112A-N).

7. The payment transaction system (106) as claimed in claim 2, wherein said each payee device (108A), further comprises a payee server that directly (i) selects one or more market promotions, (ii) communicates said one or more payer targeted market promotions to said payment integration server (110) in real time.

8. The payment transaction system (106) as claimed in claim 3, wherein said system further comprises one or more market promotion servers corresponding to said one or more payees (112A-N).

9. A method for integrating a payment transaction made by a payer (102) with a payer targeted marketing promotions, comprising:
analyzing, using a server deep data analytical engine, payer data in said payment integration server database (302), wherein said payer data comprises (i) a profile of said payer (102), (ii) a payment history of said payer (102), (iii) a spending pattern of said payer (102), and (iv) a browsing history of said payer (102);
communicating, using said payment integration server (110), said payer data to said payer device (104);
receiving, using a payer data communicating module (204), said payer data in said payer device (104) for said payer (102);
receiving, using said payment integration server (110), one or more market promotions of one or more payees (112A-N) in real time;
selecting, using said server deep data analytical engine, one or more market promotions based on said payer data;
communicating, using said payment integration server (110), one or more payer targeted market promotions to said payer device (104) in real time;
receiving, using said payer device (104), one or more payer targeted market promotions, wherein said payer targeted market promotions comprises atleast one of (i) a payer targeted coupon data, (ii) a payer targeted loyalty program data, (iii) a payer targeted marketing promotion data, or (iv) a payer targeted social media marketing data;
displaying, using said payer device (104), said one or more payer targeted market promotions related to said payment transaction that allows said payer (102) to select said one or more payer targeted market promotions by (i) manually searching and selecting said one or more payer targeted market promotions, or (ii) automatically searching and selecting against a product or a service to be purchased from said payee (112A) in said location;
initiating, using one or more payee devices (108A-N), said payment transaction by said payee (112A) against said product or said service purchased by said payer (102) in said location;
generating, using said payment integration server database (302), a link code associated with said payment transaction;
communicating, using said payment integration server database (302), said link code to said payee device 108a to display;
obtaining, using said payer device 104, by said payer 102, through atleast one of (a) QR code, (b) NFC, (c) sound tagging or (d) other similar connections;
communicating, using said payer device 104, by said payer 102 said link code back to said payment integration server 110 for establishing a connection among said payment integration server (110), said payer (102) and said payee 112A;
obtaining, using said payment integration server database (302), a payment information associated with said payment transaction initiated by said payee (112A), wherein said payment information comprises at least one of (i) a payment amount, (ii) data related to details of said product or said service purchased, wherein said data comprises atleast one of (a) details of an e-commerce website or retailer where said products or said services purchased, (b) specific and granular details of said products or said services purchased or (c) said browsing history of said payer from where said product or said service purchased is selected for purchase, (iii) a bank account details of said payer (102), (iv) a bank account details of said payee (112A), (v) a location of said payee (112A) and (vi) other details associated with said payment transaction including one or more additional market promotions;
applying, using said payment integration server (110), said one or more selected payer targeted market promotions to said payment information, wherein said payment information is modified and modified payment information is displayed using payer device (104) for said payer (102);
processing, using said payment integration server (110), said payment transaction between said payer (102) and said one or more payees (112A-N), based on said modified payment data related to said payment transaction;
storing, using said payment integration server (110), a receipt and communicating said receipt to display in said payer device (104), wherein said receipt comprises atleast one of (i) a bill for said product or said service purchased along with said payer targeted market promotions applied for said payment transaction; (ii) a warranty/guarantee information associated with said product or said service purchased and (iii) data associated with said product or said service;
communicating, using said payment integration server (110), a status to said payee device (108A) of said payment transaction on atleast one of (i) successful completion of said payment transaction, (ii) failure of said payment transaction, (iii) pending of said payment transaction or (iv) cancellation of said payment transaction,
updating, using payer data updation module (320), said payer data of said payer (102) in said payment integration server database (302), with atleast one of (i) said payment information, (ii) said modified payment data, (iii) a recent browsing history of said payer (102), (iv) a recent purchasing history of said payer (102);
displaying, using said payer device (104), said receipt after completion of said payment transaction, on atleast one of (i) successful completion of said payment transaction, (ii) failure of said payment transaction, (iii) pending of said payment transaction or (iv) cancellation of said payment transaction; and
receiving, using said one or more payee devices (108A-N), said status after completion of said payment transaction.

10. The method as claimed in claim 9, the method further comprises,
receiving, using a market promotion server (116), one or more market promotions from said one or more payees (112A-N); and
communicating, using said market promotion server (116), said one or more market promotions to said payment integration server (110) of said location in real time.

11. The method as claimed in claim 9, wherein said payer device (104) further comprises, a market promotions obtaining module, that obtains said one or more market promotions using a scanning tool associated with said payer device (104) by scanning said one or more market promotions displayed in at least one of (i) newspapers, pamphlets or other text readable formats, (ii) store aisles, billboards or wall hangings, or (iii) internet or other electronic media and stores in said payment integration server (302) for said payer (102) to utilize in said payer targeted market promotions communication module (310).

12. The method as claimed in claim 9, wherein said payer device (104) further comprises, a market promotions sharing module, that enables said payer (102) to share said plurality of payer targeted market promotions along with a message, with at least one of (i) a new payer, or (ii) a plurality of new payers, using a social media tool associated with said payment transaction system (106) to download and utilize in said payer targeted market promotions communication module (310).

13. The method as claimed in claim 9, wherein said payment transaction system comprises a plurality of payer devices (104) for initiating a plurality of payment transactions against a plurality of products or services purchased from said one or more payees (112A-N).

14. The method as claimed in claim 9, wherein said each payee device (108A), further comprises a payee server that directly (i) selects one or more market promotions, (ii) communicates said one or more payer targeted market promotions to said payment integration server (110) in real time.

15. The method as claimed in claim 10, wherein said method further comprises one or more market promotion servers corresponding to one or more payees (112A-N).
